(19) United States
(12) Patent Application Publication
(10) Pub. No.: US 2015/0177971 A1
(43) Pub. Date: Jun. 25, 2015

(54) ELECTRONIC DEVICE AND A METHOD FOR CONTROLLING THE SAME

(71) Applicant: Han Uk JEONG, Seoul (KR)

(72) Inventor: Han Uk JEONG, Seoul (KR)

(21) Appl. No.: 14/469,567

(22) Filed: Aug. 26, 2014

(30) Foreign Application Priority Data
Jul. 2, 2013 (KR) 10-2013-0077221

(51) Int. Cl. G06F 3/0484; G06F 3/0482

(52) U.S. Cl. CPC G06F 3/04847; G06F 3/0482

(57) ABSTRACT

An electronic device comprises an input unit configured to receive information generated by manipulating a key or a menu, a controller configured to execute a first function according to the information received from the input unit, and a display unit configured to display an image associated with a control signal from the controller, wherein the controller is configured to, when a second function is selected while the first function is executed, execute the second function and display a window on a predetermined area of a first screen on which the execution of the first function is displayed, the window providing information associated with the selected second function.

### CROSS-REFERENCE TO RELATED APPLICATIONS

This U.S. non-provisional patent application claims priority under 35 U.S.C. §119 to Korean Patent Application No. 10-2013-0077221, filed on Jul. 2, 2013, in the Korean Intellectual Property Office, the disclosure of which is incorporated by reference herein in its entirety.

### TECHNICAL FIELD

Exemplary embodiments of the inventive concept relate to an electronic device, and more specifically, to an electronic device that may display a control window for executing a function on the screen while another function is running without obstructing the other function.

### DISCUSSION OF RELATED ART

Various types of mobile devices are available to transmit/receive various information wiredly or wirelessly, such as cellular phones, personal digital assistants (PDAs), Blackberry® devices, smartphones, etc. These devices can store and process an increasing amount of information, including image, video, or music files. Many of these devices include a color screen that can display images (graphics) as well as text. Some of these devices are equipped with a global positioning system (GPS) receiver so as to function as a navigation system, in addition to functioning as a communications device and processing images and sounds. As is well known in the art, a navigation system can receive a destination location from a user, calculate suitable directions to go from the user's current position, as determined based on data obtained by the GPS receiver, to the destination location, and display the directions together with a relevant map on its screen. The directions and a map as displayed on the screen are constantly updated based on the current (moving) position of the user as determined based on data obtained by the OPS receiver. In current navigation systems, however, the operative screen of the navigation screen needs to be closed or collapse to show the operative screen of another function. For example, the user who desires to play an MP3 file while the navigation is in operation needs first to close the navigation screen to show a screen for setting or executing the music player application.

### SUMMARY

According to an exemplary embodiment of the inventive concept, an electronic device comprises an input unit configured to receive information generated by manipulating a key or a menu, a controller configured to execute a first function according to the information received from the input unit, and a display unit configured to display an image associated with a control signal from the controller. The controller is configured to, when a second function is selected while the first function is executed, execute the second function and display a window on a predetermined area of a first screen on which the execution of the first function is displayed, the window providing information associated with the selected second function.

The controller is configured to hide the window and to re-display the window after a predetermined time in response to a signal generated by touching a portion other than the window.

The controller is configured to overlay the window on the predetermined area of the first screen.

The controller is configured to split the first screen into two or more portions and to display the window on one of the two or more portions.

The electronic device may further comprise a communication unit configured to connect the electronic device to a network, the controller configured to receive a music file from a server through the communication unit and to reproduce the music file.

The controller is configured to connect the electronic device to a second electronic device through the communication unit and to transmit a control signal to the second electronic device to control the second electronic device.

The controller is configured to perform different types of control in response to input signals generated by touching the window and sliding a touch on the window in different directions.

The controller is configured to stop the second function in response to a signal generated by a first touch on the window and to resume the stopped second function in response to a signal generated by a second touch on the window while the second function is stopped.

The controller is configured to display a volume control part in response to a signal generated by double-touching the window, the volume control part configured to allow a user to control the sound volume of the electronic device.

The second function is a music reproduction function, and the controller is configured to reproduce a music file previous to a currently reproduced music file among music files stored in a memory in response to a signal generated by sliding a touch on the window in a first direction.

The second function is a music reproduction function, and the controller is configured to reproduce a music file next to a currently reproduced music file among music files stored in a memory in response to a signal generated by sliding a touch on the window in a second direction.

The controller is configured to display a setting screen for setting the window in response to a signal generated by sliding a touch on the window in a third direction.

The second function is a music reproduction function, and the controller is configured to display predetermined information including a song title and a singer's name at a predetermined position of the first screen in response to a signal generated by sliding a touch on the window in a fourth direction.

The controller is configured to adjust a transparency of the window.

The controller is configured to change a color of a portion or whole of the window according to whether the second function is executed.

The second function is a music reproduction function, and the information associated with the second function includes at least one of a song title, a singer's name, or a music file reproduction time, or an album image.

According to an exemplary embodiment of the inventive concept, a method for controlling an electronic device comprises activating a first function and displaying a first screen associated with the first function, identifying whether a second function is selected while the first function is activated, when the second function is selected, executing the second function and displaying a window on a predetermined area of the first screen, the window providing information associated with the selected second function.

The method may further comprise hiding the window and re-displaying the window after a predetermined time in response to a signal generated by touching a portion other than the window.

The method may further comprise overlaying the window on the predetermined area of the first screen.

The method may further comprise splitting the first screen into two or more portions and displaying the window on one of the two or more portions.

The method may further comprise performing different types of control in response to input signals generated by touching the window and sliding a touch on the window in different directions.

The method may further comprise stopping the second function in response to a signal generated by a first touch on the window and resuming the stopped second function in response to a signal generated by a second touch on the window while the second function is stopped.

The second function is a music reproduction function, the method further comprising reproducing a music file previous to a currently reproduced music file among music files stored in a memory in response to a signal generated by sliding a touch on the window in a first direction.

The second function is a music reproduction function, the method further comprising reproducing a music file next to a currently reproduced music file among music files stored in a memory in response to a signal generated by sliding a touch on the window in a second direction.

The method may further comprise displaying a setting screen for setting the window in response to a signal generated by sliding a touch on the window in a third direction.

The second function is a music reproduction function, the method comprising displaying predetermined information including a song title and a singer's name at a predetermined position of the first screen in response to a signal generated by sliding a touch on the window in a fourth direction.

The method may further comprise adjusting a transparency of the window.

The method may further comprise changing a color of a portion or whole of the window according to whether the second function is executed.

The second function is a music reproduction function, and the information associated with the second function includes at least one of a song title, a singer's name, or a music file reproduction time, or an album image.

### BRIEF DESCRIPTION OF DRAWINGS

A more complete appreciation of the present disclosure and many of the attendant aspects thereof will be readily obtained as the same becomes better understood by reference to the following detailed description when considered in connection with the accompanying drawings, wherein:

FIG. 1 is a block diagram illustrating an electronic device for reproducing a music file while providing an additional function service according to an exemplary embodiment of the inventive concept;

FIG. 2 is a flowchart illustrating a control method for reproducing a music file while executing an additional function according to an exemplary embodiment of the inventive concept;

FIG. 3 is a screen view of an electronic device for reproducing a music file while in execution of an additional function according to an exemplary embodiment of the inventive concept;

FIG. 4 illustrates an example setting screen for a music reproduction function of an electronic device for reproducing a music file while in execution of an additional function according to an exemplary embodiment of the inventive concept;

FIG. 5 is a view illustrating an example of stopping music reproduction in an electronic device for reproducing a music file while in execution of an additional function according to an exemplary embodiment of the inventive concept;

FIG. 6 is a view illustrating an example of controlling a music reproduction function in an electronic device for reproducing a music file while in execution of an additional function according to an exemplary embodiment of the inventive concept;

FIG. 7 is a view illustrating an example of performing control to show music reproduction information in an electronic device for reproducing a music file while in execution of an additional function according to an exemplary embodiment of the inventive concept;

FIG. 8 is a view illustrating an example of performing control to show a volume control part in an electronic device for reproducing a music file while in execution of an additional function according to an exemplary embodiment of the inventive concept;

FIG. 9 is a screen view of an electronic device for reproducing a music file while in execution of an additional function according to an exemplary embodiment of the inventive concept;

FIG. 10 is a view illustrating an example of stopping music reproduction in an electronic device for reproducing a music file while in execution of an additional function according to an exemplary embodiment of the inventive concept;

FIG. 11 is a view illustrating an example of controlling a music reproduction function in an electronic device for reproducing a music file while in execution of an additional function according to an exemplary embodiment of the inventive concept;

FIG. 12 is a view illustrating an example of performing control to show music reproduction information in an electronic device for reproducing a music file while in execution of an additional function according to an exemplary embodiment of the inventive concept;

FIG. 13 is a view illustrating an example of performing control to show a volume control part in an electronic device for reproducing a music file while in execution of an additional function according to an exemplary embodiment of the inventive concept;

FIG. 14 is a screen view of an electronic device for reproducing a music file while in execution of an additional function according to an exemplary embodiment of the inventive concept;

FIG. 15 is a view illustrating an example of stopping music reproduction in an electronic device for reproducing a music file while in execution of an additional function according to an exemplary embodiment of the inventive concept;

FIG. 16 is a view illustrating an example of controlling a music reproduction function in an electronic device for reproducing a music file while in execution of an additional function according to an exemplary embodiment of the inventive concept;

FIG. 17 is a view illustrating an example of performing control to show music reproduction information in an electronic device for reproducing a music file while in execution of an additional function according to an exemplary embodiment of the inventive concept;

FIG. 18 is a view illustrating an example of performing control to show a volume control part in an electronic device for reproducing a music file while in execution of an additional function according to an exemplary embodiment of the inventive concept; and

FIG. 19 is a screen view of an electronic device for reproducing a music file while in execution of an additional function according to an exemplary embodiment of the inventive concept.

### DETAILED DESCRIPTION OF EMBODIMENTS

Hereinafter, exemplary embodiments of the inventive concept will be described in detail with reference to the accompanying drawings. The same reference denotations may be used to refer to the same or substantially the same elements throughout the specification and the drawings. The inventive concept, however, may be modified in various different ways, and should not be construed as limited to the embodiments set forth herein.

It will be understood that when an element or layer is referred to as being “on,” “connected to,” “coupled to,” or “adjacent to” another element or layer, it can be directly on, connected, coupled, or adjacent to the other element or layer, or intervening elements or layers may be present. As used herein, the singular forms “a,” “an,” and “the” are intended to include the plural forms as well, unless the context clearly indicates otherwise.

As will be appreciated by one skilled in the art, aspects of the present inventive concept may be embodied as a system, method or computer program product. Accordingly, aspects of the present inventive concept may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present inventive concept may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a RAM, a ROM, an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present inventive concept may be written in any combination of one or more programming languages, including an object oriented programming language such as Java, Smalltalk. C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present inventive concept are described with reference to flowchart illustrations and/or block diagrams of methods, apparatus (systems) and computer program products according to embodiments of the inventive concept. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article or manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the figures illustrate the architecture, functionality, and operation of possible implementations of systems, methods and computer program products according to various embodiments of the present inventive concept. In this regard, each block in the flowchart or block diagrams may represent a module, segment, or portion of code, which comprises one or more executable instructions for implementing the specified logical functions(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

As used herein, the term “additional function” refers to a function that is performed by an electronic device according to an exemplary embodiment of the inventive concept and is used to distinguish the same function from another function that is also performed by the electronic device. Accordingly, it should be appreciated that the additional function is not limited to a particular function as performed by the electronic device.

As used herein, the term “music file” may refer to any music data that includes a music stream downloaded from a server over a network, unless mentioned otherwise.

As used herein, the term “reproduce a music file” may refer to outputting a music file in any form, such as, e.g., a sound or voice, which includes, but not limited to, playing, replaying, or playing back a music file or music stream or other music data, unless stated otherwise.

In other words, exemplary embodiments of the inventive concept apply to the case of playing, replaying, or playing back music streams (downloaded from a server) or any other types of music data or information, as well as the case of reproducing a music file(s).

However, for ease of description, exemplary embodiments in which a music file is reproduced are described, but the inventive concept are not limited thereto.

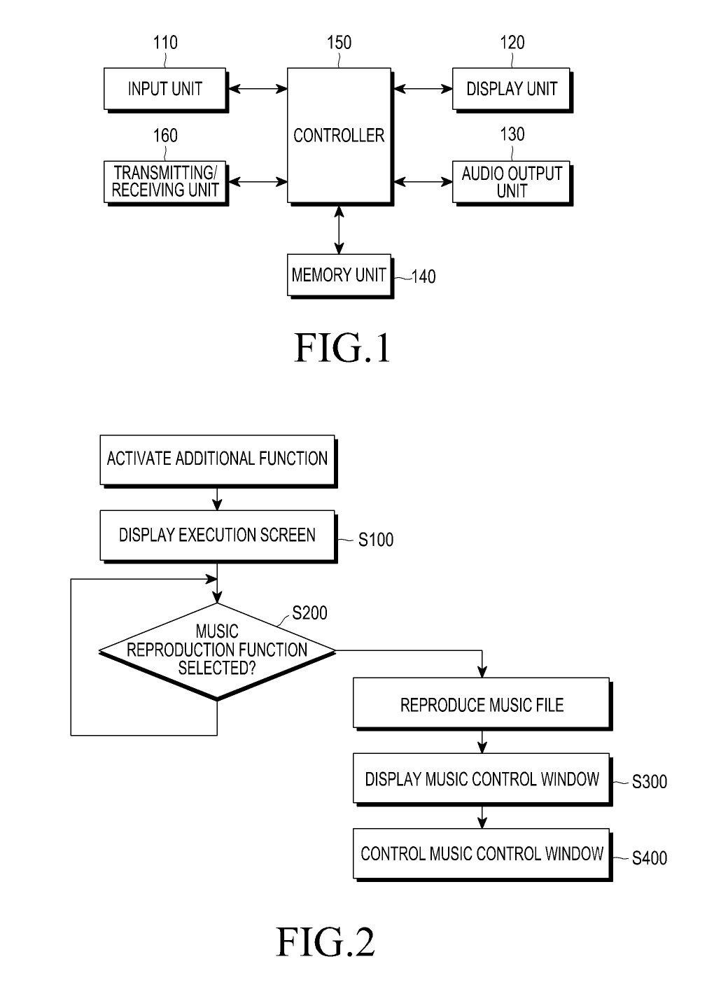

FIG. 1 is a block diagram illustrating an electronic device for reproducing a music file while providing an additional function service according to an exemplary embodiment of the inventive concept.

Referring to FIG. 1, the electronic device may include an input unit 110, a display unit 120, an audio output unit 130, a memory 140, and a controller 150.

According to an exemplary embodiment of the inventive concept, the electronic device may include, but is not limited to, an embedded-type navigation device that may be embedded in a vehicle's dashboard panel, a mounted-type navigation device separately mounted in a vehicle, or other portable devices that may receive a mobile communication service through a mobile communication network. The portable devices may include, but is not limited to, a mobile phone, a smartphone, a laptop computer, or a personal digital assistant (PDA).

The input unit 110 may receive information that is generated in response to a user's manipulation of a key or menu. For example, the input unit 110 may be a touch screen that may receive an input by the user's touch thereon. The user may input a command for executing an additional function through the input unit 110 and may send a control signal for the additional function. For example, the user may select a function for reproducing a music file through the input unit 110. When selecting the function for reproducing a music file through the input unit 110, the user may set up the music file reproducing function through the input unit 110 to display information relating to reproduction of the music file.

The display unit 120 may display an additional function in execution on the screen. For example, when a music reproducing function is selected while an additional function runs, the display unit 120 may receive a control signal from the controller 150 and may display a music control window on a predetermined area of the screen on which the additional function is displayed. The screen on which the additional function is displayed may also be simply referred to as additional function screen. The music control window may provide information on the reproduction of the music file.

The audio output unit 130 may output an audio signal, e.g., an audio signal contained in the additional function, while the additional function is executed. The audio output unit 130 may output a music sound when a music reproducing function is selected.

The memory 140 may store an application for an additional function. For example, when the electronic device provides a navigation service, the memory 140 may store map data and a navigation application. According to an exemplary embodiment of the inventive concept, the memory 140 may store music files, a music reproducing application for reproducing the music files, and album images or videos.

The controller 150 drives the electronic device and executes an additional function in response to an input signal from the input unit 110. For example, when receiving a signal for executing an additional function from the input unit 110, the controller 150 executes the additional function and displays the additional function through the display unit 120. In this case, while a music reproducing function is selected while the additional function is in execution, the controller 150 performs control so that a music file is reproduced and a music control window providing music reproduction information associated with the selected music reproduction function is displayed on a predetermined area of the screen on which the executed additional function is displayed.

In this case, the controller 150 may perform control so that the music control window is overlaid on the predetermined area of the additional function screen. Alternatively, the controller 150 may perform control so that the additional function screen may be split and the music control window is displayed on a split portion of the additional function screen.

In response to a signal generated by touching a portion other than the music control window (such signal is simply referred to a ‘touch signal’), the controller 150 may perform control to hide the music control window and to re-display the music control window a predetermined time after receiving the touch signal.

According to an exemplary embodiment of the inventive concept, the controller 150 may perform control so that a music file is reproduced in response to a signal generated by touching the music control window or in response to an input signal generated depending on a direction along which a touch slides on the screen.

For example, the controller 150 may perform control to temporarily stop reproducing a music file in response to a signal generated by touching once the music control window while the music file is reproduced and to resume reproducing the music file in response to a signal generated by touching once more the music control window while the music file stops being reproduced.

According to an exemplary embodiment of the inventive concept, the controller 150 may perform control to display a volume control part for volume control on the screen in response to a signal generated by touching twice the music control window, thus allowing the user to control volume using the volume control unit.

According to an exemplary embodiment of the inventive concept, the controller 150 may perform control to reproduce a music file previous to the currently reproduced music file among the music files included in a music file list or stored in a music file area of, e.g., the memory 140 in response to a signal generated by sliding a touch on the music control window in a left direction.

According to an exemplary embodiment of the inventive concept, the controller 150 may perform control to reproduce a music file next to the currently reproduced music file among the music files included in the music file list or stored in the music file area of, e.g., the memory 140 in response to a signal generated by sliding a touch on the music control window in a right direction.

According to an exemplary embodiment of the inventive concept, the controller 150 may perform control to display a setting screen for the music control window in response to a signal generated by sliding a touch on the music control window in an upper direction.

According to an exemplary embodiment of the inventive concept, the controller 150 may perform control to display a song title or a singer's name at a middle of the screen in response to a signal generated by sliding a touch on the music control window in a lower direction.

Exemplary embodiments of the inventive concept are not limited to the above-described directions of the manipulation (such as touching or sliding a touch) on the music control window. For example, various other types of control, as well as the above-described types of control may be set as necessary in association with a diagonal direction or a combination of two or more directions.

According to an exemplary embodiment of the inventive concept, the electronic device may further include a communication unit 160. The communication unit 160 may wiredly or wirelessly transmit or receive various types of information. For example, the communication unit 160 may transmit or receive various types of information, such as signals over the Internet, radio signals, or digital multimedia broadcasting (DMB) signals.

The controller 150 may be configured to control or play an external electronic device, such as a radio, an audio system, a compact disc (CD) player, a universal serial bus (USB) memory device, an MP3 player, a smartphone, or a tablet PC, or other mobile communication devices, in association with the external electronic device, by way of, e.g., a near-field wireless communication using the communication unit 160, thus allowing a music file to be reproduced through the external electronic device or allowing the user to listen to the radio.

According to an exemplary embodiment of the inventive concept, the 150 may perform control to reproduce a music file that is provided from an Internet music service provider or website through the Internet using the communication unit 160.

The music reproduction information displayed on the music control window may include, but is not limited to, a song title, a singer's name, a reproduction time of the music file, and an album image. The album image may be displayed as a background image in the music control window, and the song title (e.g., “Lupin”) and singer's name (e.g., “Kara”) may be overlaid on the background image, as shown in the drawings.

A method for reproducing a music file while executing an additional function is now described according to an exemplary embodiment of the inventive concept.

FIG. 2 is a flowchart illustrating a control method for reproducing a music file while executing an additional function according to an exemplary embodiment of the inventive concept.

Referring to FIG. 2, the control method may include the steps of displaying an additional function screen as an additional function is activated (S100), identifying whether a music reproduction function is selected while the additional function is activated (S200), and reproducing a music file and displaying a music control window providing music reproduction information on a predetermined area of the additional function screen when the music reproduction function is selected (S300).

In step S100, the controller 150 receives an input signal for activating the additional function from the input unit 110, activates the additional function, and displays the additional function screen on the display unit 120.

In step S200, it is identified whether the music reproduction function is selected while the additional function is activated. In step S100, the additional function is activated, and in step S200, it is identified whether the music reproduction function is selected through the input unit 110.

In step S300, a music file is reproduced, and a music control window providing music reproduction information is displayed on a predetermined area of the additional function screen when the music reproduction function is identified to be selected in step S200. Reproducing the music file may be performed simultaneously or substantially simultaneously with displaying the music control window.

In response to a signal generated by touching a portion other than the music control window, the music control window may be hidden, and then music control window may be displayed back a predetermined time after the signal has been received.

In step S300, the music control window may be controlled to be displayed overlaid on the predetermined area of the additional function screen. Alternatively, in step S300, the additional function screen may be split, and the music control window may be displayed on a split portion of the additional function screen.

According to an exemplary embodiment of the inventive concept, the control method may further include the step of performing control in response to a signal generated by touching the music control window or in response to an input signal generated by sliding a touch on the music control window. In this case, different types of control may be performed depending on directions in which the touch slides.

For example, in step S400, in response to a signal generated by touching once the music control while the music reproduction is performed, the music reproduction may be controlled to be temporarily stopped, and in response to a signal generated by touching once the music control window while the music reproduction stays stopped, the temporarily stopped music reproduction may be controlled to be resumed.

According to an exemplary embodiment of the inventive concept, when a touch on the music control window slides in a left direction, a music file previous to the currently reproduced music file among the music files included in a music file list or stored in a music file area of, e.g., the memory 140, may be controlled to be reproduced.

According to an exemplary embodiment of the inventive concept, when a touch on the music control window slides in a right direction, a music file next to the currently reproduced music file among the music files included in the music file list or stored in the music file area of, e.g., the memory 140, may be controlled to be reproduced.

According to an exemplary embodiment of the inventive concept, when a touch on the music control window slides in an upper direction, a setting screen for the music reproduction function may be controlled to be displayed.

According to an exemplary embodiment of the inventive concept, when a touch on the music control window slides in a lower direction, predetermined information, such as, e.g., a song title or a singer's name, may be configured to be displayed magnified on a middle of the screen.

According to an exemplary embodiment of the inventive concept, in step S300, the transparency of the music control window may be adjusted. The color of the music control window may be varied in part or whole depending on whether a music file is reproduced. The music reproduction information displayed on the music control window may include, but is not limited to, at least one of the song title, singer's name, album image, and/or reproduction time of the reproduced music file.

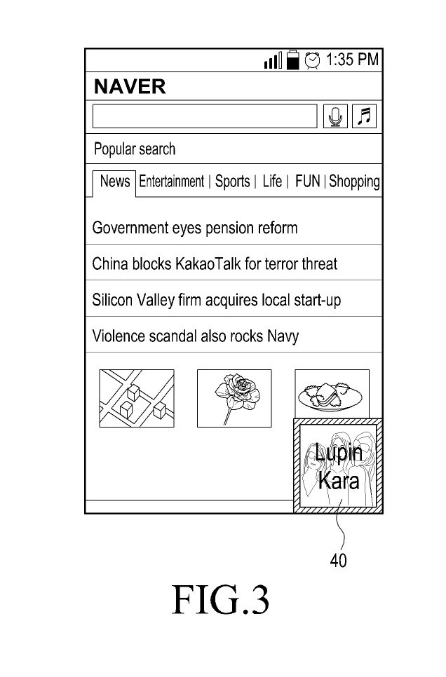

FIG. 3 is a screen view of an electronic device for reproducing a music file while in execution of an additional function according to an exemplary embodiment of the inventive concept.

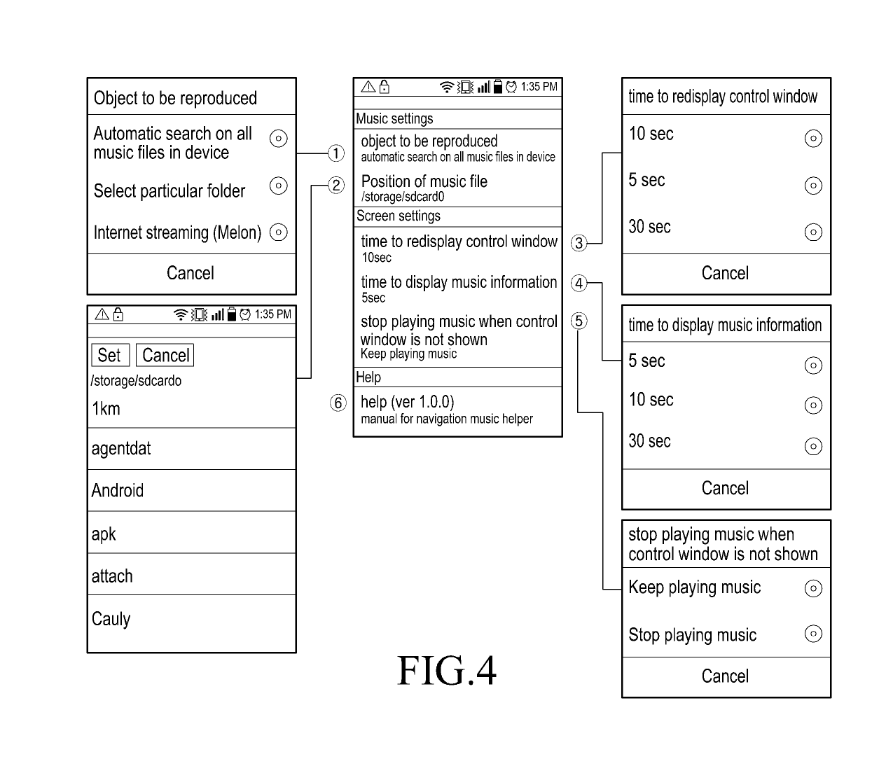

FIG. 4 illustrates an example of setting a music reproduction function using an electronic device for reproducing a music file while in execution of an additional function according to an exemplary embodiment of the inventive concept.

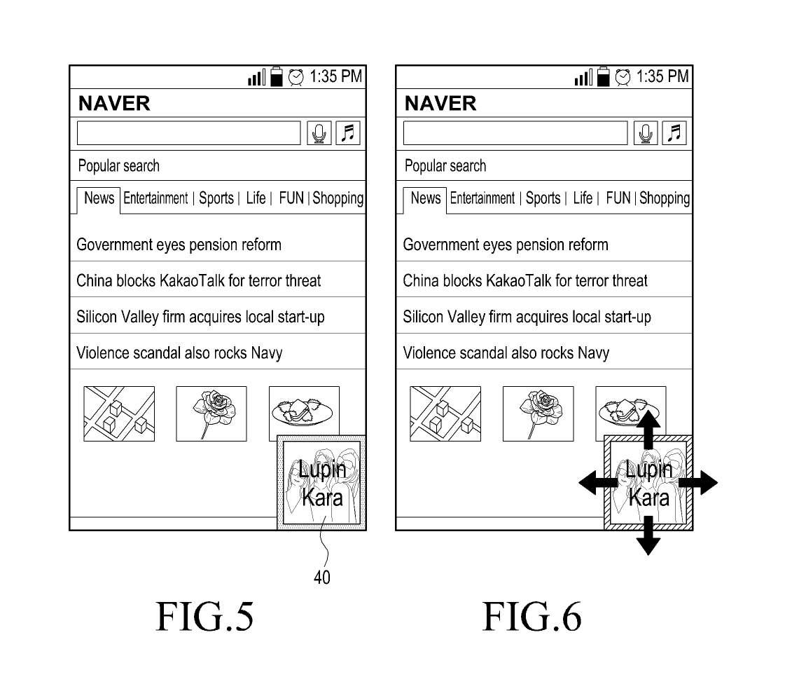

FIG. 5 is a view illustrating an example of stopping music reproduction in an electronic device for reproducing a music file while in execution of an additional function according to an exemplary embodiment of the inventive concept.

FIG. 6 is a view illustrating an example of controlling a music reproduction function in an electronic device for reproducing a music file while in execution of an additional function according to an exemplary embodiment of the inventive concept.

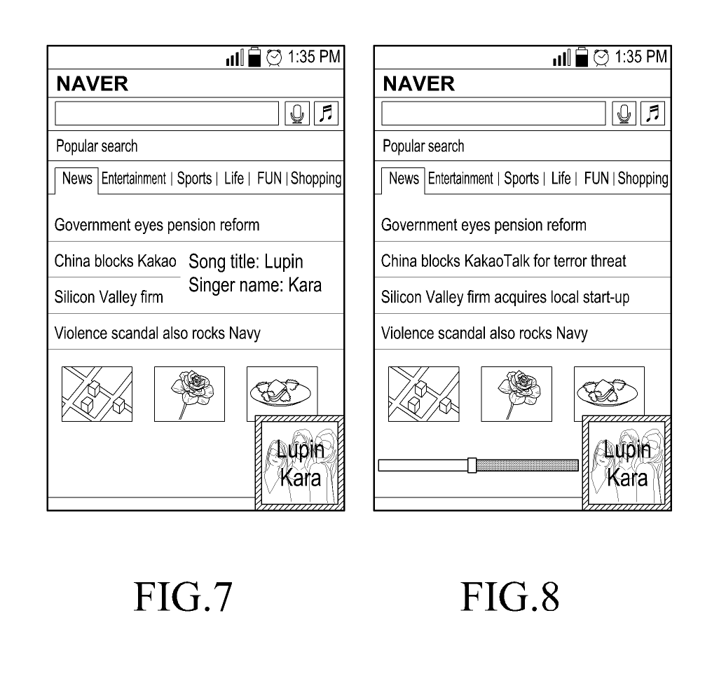

FIG. 7 is a view illustrating an example of performing control to show music reproduction information in an electronic device for reproducing a music file while in execution of an additional function according to an exemplary embodiment of the inventive concept.

FIG. 8 is a view illustrating an example of performing control to show a volume control part in an electronic device for reproducing a music file while in execution of an additional function according to an exemplary embodiment of the inventive concept.

Referring to FIG. 3, according to an exemplary embodiment of the inventive concept, an additional function, such as, e.g., web browsing, is executed, and a music control window 40 is displayed overlaid on the additional function screen. The position and size of the music control window 40 is merely an example, and may be adjusted or varied.

According to an exemplary embodiment of the inventive concept, the electronic device for reproducing a music file while in execution of an additional function starts its operation and displays a main menu screen including a first application icon associated with a first application (e.g., an additional function) and a second application icon associated with a second application.

When the second application icon is identified to be selected from the main menu screen, the second application is executed and a service setting screen is displayed. Through the service setting screen, an object to be reproduced, the position of a music file, time to re-display control window, a time period for displaying music information, and whether to stop music reproduction when the control window is not shown may be set or configured.

FIG. 4 illustrates an example setting screen for a music reproduction function of an electronic device for reproducing a music file while in execution of an additional function according to an exemplary embodiment of the inventive concept. The music reproduction function setting screen 20 is described below in greater detail.

Through item \textcircled{1}, all the music files in the electronic device may be automatically searched, a particular folder may be selected, or Internet streaming (e.g., Melon™ or Olle Music™) may be selected.

Through item \textcircled{2}, the position of a music file may be set. For example, when the position in which a music file is stored in a memory, such as the memory 140, is preset, the music file stored at the position may be reproduced upon music file reproduction. When the Internet streaming is selected in item \textcircled{1}, the position of the music file is a virtual folder position, and when the Internet radio is selected in item \textcircled{1}, the position of the music file is an Internet radio channel.

Through item \textcircled{3}, a time to re-display the music control window 40 may be set. When a portion other than the music control window 40 is touched, the music control window 40 may disappear for a predetermined time, and after another predetermined time, the music control window 40 may be automatically displayed back on the additional function screen.

Through item \textcircled{4}, a time to display music information may be set. For example, when the music control window 40 slides down, a time to magnify or display a song title and a singer's name on the screen may be set.

Through item \textcircled{5}, whether to stop music reproduction when the music control window 40 is not shown may be set.

Through item \textcircled{6}, a help may be shown.

The description of the setting screen may also be applicable to the following exemplary embodiments of the inventive concept.

Referring to FIG. 5, the music control window 40 includes music reproduction information, such as, for example, a song title, a singer's name, a time to reproduce a music file, and an album image. The music control window 40 is displayed in a first color and waits for music reproduction.

Under such circumstance, information on the music file reproduced last is displayed, and the music file is not immediately reproduced.

When the music control window 40 is touched to thus reproduce the music file, the color of the music control window 40 changes to a second color to indicate that the music file is produced as shown in FIG. 3, and the music file is reproduced.

For example, when the music reproduction is stopped, the music control window 40 may be displayed in red, and when the music reproduction is performed, the music control window 40 may be displayed in green. When the music control window 40 displayed in red is touched, the color of the music control window 40 may be changed to green, and the music file may be reproduced. According to an exemplary embodiment of the inventive concept, changing to the second color may be performed substantially simultaneously with reproducing the music file. The first color and the second color may be, but not limited to, red and green or vice versa, or the first color and the second color may have other various colors.

When the time to display the music file information on the service setting screen is identified to have been changed, the music file information may be hidden. For example, the music control window 40 may be displayed overlaid on the additional function screen without displaying the music file information.

When a portion other than the music control window 40 is touched with the music control window 40 displayed, the music control window 40 may be hidden, with the additional function screen displayed. In such case, a predetermined time after the touch, the music control window 40 may be displayed back. The predetermined time may be selectively adjusted.

Stopping the music reproduction function includes “stopping music reproduction when control window is not shown” and stopping the music control window by touching the additional function screen in the step of setting a service. For example, when the service setting step is configured to “keep playing music,” the music reproduction goes on even when the music control window 40 is hidden, but otherwise, the music reproduction may be terminated.

As shown in FIG. 6, the user may control the music reproduction function using the music control window 40. The music control window 40 may be controlled in various manners, e.g., by touching the music control window 40 or by sliding a touch on the music control window 40 in different directions.

For example, as shown in FIG. 7, the user may perform control to display music reproduction information on the additional function screen by sliding the music control window 40 in an upper direction. As shown in FIG. 8, the user may perform control to display a volume control part by touching twice the music control window 40 to allow the user to adjust the volume.

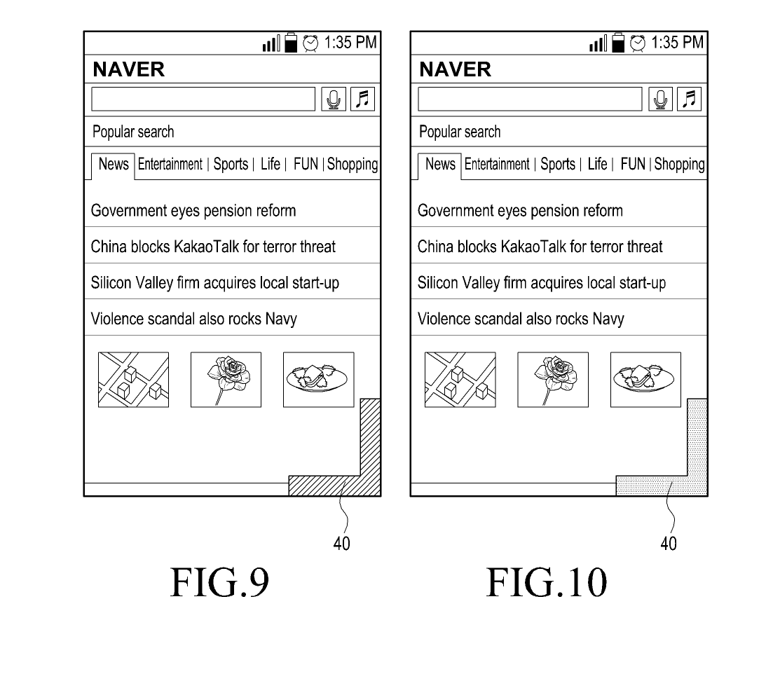

FIG. 9 is a screen view of an electronic device for reproducing a music file while in execution of an additional function according to an exemplary embodiment of the inventive concept.

FIG. 10 is a view illustrating an example of stopping music reproduction in an electronic device for reproducing a music file while in execution of an additional function according to an exemplary embodiment of the inventive concept.

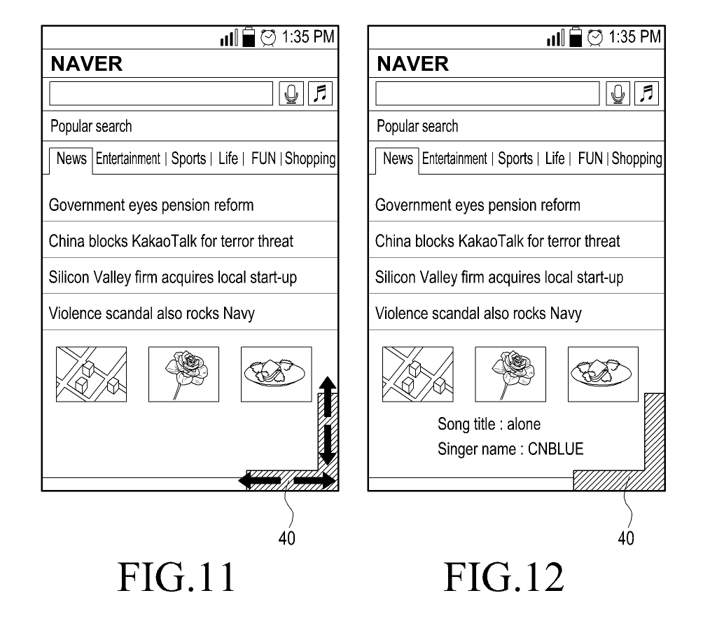

FIG. 11 is a view illustrating an example of controlling a music reproduction function in an electronic device for reproducing a music file while in execution of an additional function according to an exemplary embodiment of the inventive concept.

FIG. 12 is a view illustrating an example of performing control to show music reproduction information in an electronic device for reproducing a music file while in execution of an additional function according to an exemplary embodiment of the inventive concept.

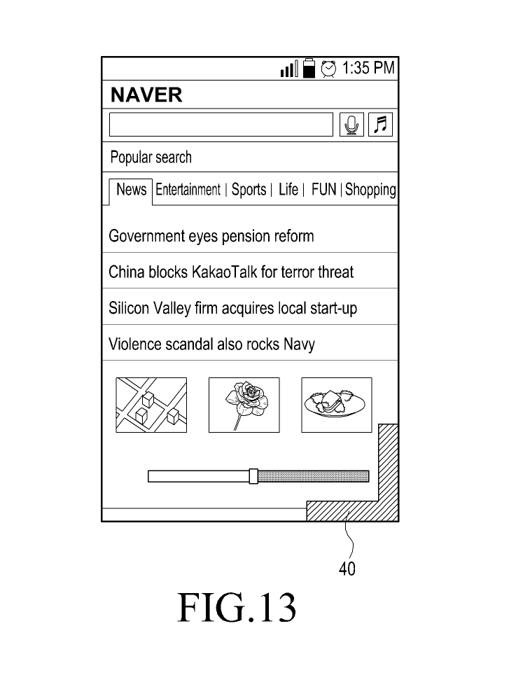

FIG. 13 is a view illustrating an example of performing control to show a volume control part in an electronic device for reproducing a music file while in execution of an additional function according to an exemplary embodiment of the inventive concept.

Referring to FIG. 9, the music control window 40 may have a bent shape positioned at a corner of the additional function screen. For example, the music control window 40 may be shaped like the letter “L.” In this case, the music control window 40 might not include music reproduction information.

FIG. 10 illustrates an example of the music control window 40 under the state in which music reproduction is stopped.

Referring to FIG. 11, the music reproduction may be controlled by sliding an ‘I’-shaped portion of the music control window 40 in upper and lower directions. Alternatively, the music reproduction may be controlled by sliding a ‘-’-shaped portion of the music control window 40 in left and right directions.

For example, music reproduction information may be displayed on a portion of the additional function screen for a predetermined time by sliding the ‘I’-shaped portion of the music control window 40 in a lower direction, as shown in FIG. 12. A volume control part may be generated to adjust the volume by double-clicking (or by double-touching) the music control window 40, as shown in FIG. 13.

The ‘-’-shaped portion of the music control window 40 may be used for reproducing a previous music file or a next music file. For example, when the ‘-’-shaped portion of the music control window 40 slides in a right direction of the screen, a next music file may be reproduced, and when the ‘-’-shaped portion of the music control window 40 slides in a left direction of the screen, a previous music file may be reproduced. According to an exemplary embodiment of the inventive concept, upon switch to the previous or next music file, music reproduction information may be displayed on a portion of the screen for a predetermined time, allowing the user to easily identify the music reproduction information.

According to an exemplary embodiment of the inventive concept, the color of the ‘L’-shaped music control window 40 may be changed between when music reproduction is performed and when music reproduction is stopped.

For example, when the music reproduction is stopped, the music control window 40 may be displayed in red, and when the music reproduction is performed, the music control window 40 may be displayed in green. When the music control window 40 displayed in red is touched, the color of the music control window 40 may be changed to green, and the music file may be reproduced. According to an exemplary embodiment of the inventive concept, changing to the second color may be performed substantially simultaneously with reproducing the music file. The first color and the second color may be, but not limited to, red and green or vice versa, or the first color and the second color may have other various colors.

The music control window 40 doses not occupy a lot the additional function screen. According to an exemplary embodiment of the inventive concept, even when a portion other than the music control window 40 is touched, the music control window 40 might not disappear from the screen. Making the music control window 40 appear or disappear may be chosen in the settings of the electronic device.

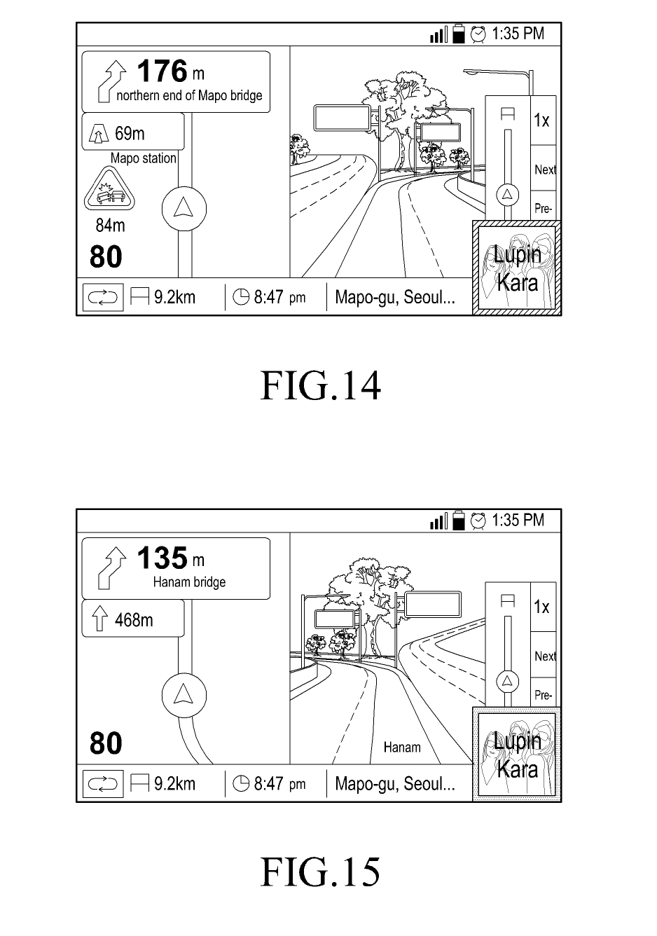

FIG. 14 is a screen view of an electronic device for reproducing a music file while in execution of an additional function according to an exemplary embodiment of the inventive concept.

FIG. 15 is a view illustrating an example of stopping music reproduction in an electronic device for reproducing a music file while in execution of an additional function according to an exemplary embodiment of the inventive concept.

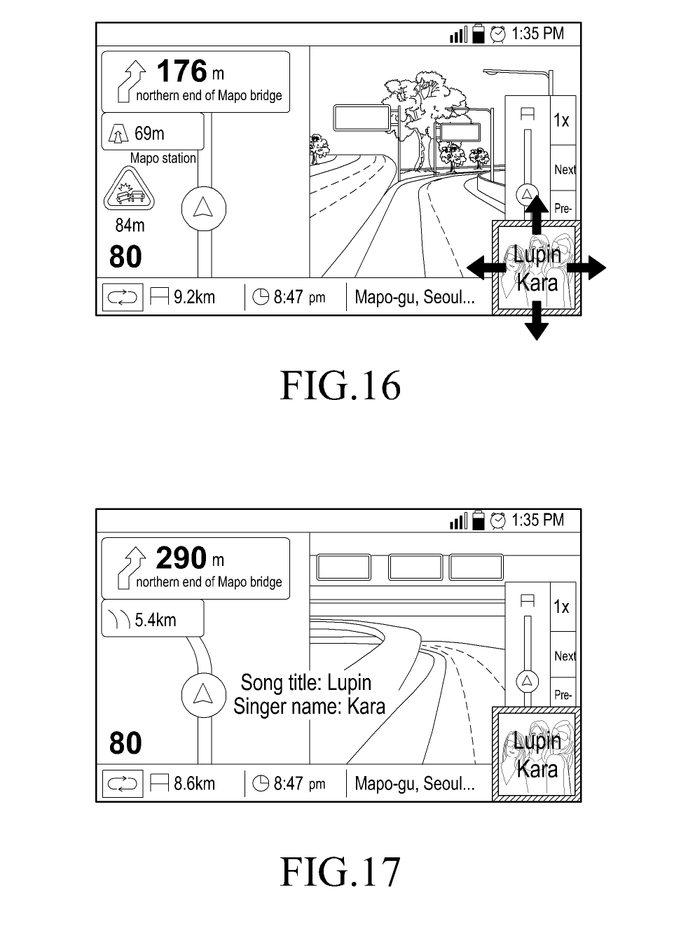

FIG. 16 is a view illustrating an example of controlling a music reproduction function in an electronic device for reproducing a music file while in execution of an additional function according to an exemplary embodiment of the inventive concept.

FIG. 17 is a view illustrating an example of performing control to show music reproduction information in an electronic device for reproducing a music file while in execution of an additional function according to an exemplary embodiment of the inventive concept.

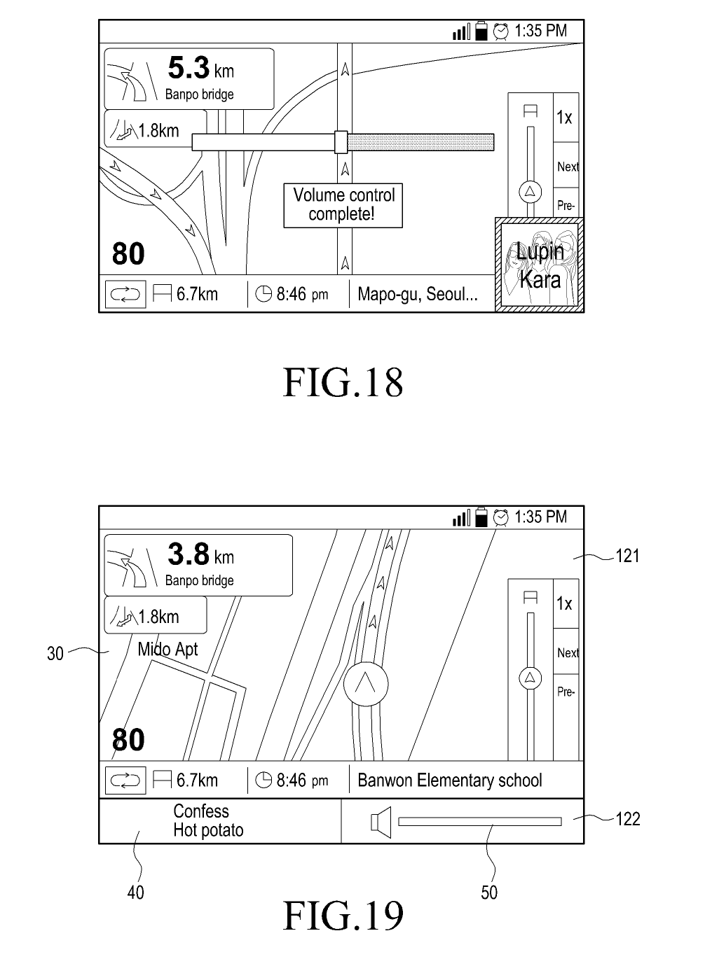

FIG. 18 is a view illustrating an example of performing control to show a volume control part in an electronic device for reproducing a music file while in execution of an additional function according to an exemplary embodiment of the inventive concept.

Referring to FIG. 14, a predetermined time after a navigation service is activated in response to the user's clicking (or touching) a navigation icon, music reproduction is initiated, and a music control window 40 is displayed overlaid on a portion of the navigation screen. Music reproduction may be performed substantially simultaneously with displaying the music control window 40.

FIG. 15 illustrates the state in which the music reproduction is stopped. The color of the music control window 40 when the music reproduction is stopped is different from the color of the music control window 40 when the music reproduction is performed.

For example, when the music reproduction is stopped, the music control window 40 may be displayed in red, and when the music reproduction is performed, the music control window 40 may be displayed in green. When the music control window 40 displayed in red is touched, the color of the music control window 40 may be changed to green, and the music file may be reproduced. According to an exemplary embodiment of the inventive concept, changing to the second color may be performed substantially simultaneously with reproducing the music file. The first color and the second color may be, but not limited to, red and green or vice versa, or the first color and the second color may have other various colors.

Referring to FIG. 16, the user may control the music reproduction by touching the music control window 40 or sliding the music control window 40 with the music control window 40 touched. For example, the user may perform control to temporarily stop or resume music reproduction. For example, the user may perform control through the music control window 40, e.g., so that the output of a navigation voice is performed together with music reproduction or music reproduction is temporarily stopped to listen to only the navigation voice.

As shown in FIG. 17, the electronic device may be controlled so that music reproduction information is displayed on the screen depending on a direction in which a touch on the music control window 40 slides. As shown in FIG. 18, a volume control part may show up on the screen by double-touching the music control window 40, thus allowing the user to adjust the volume of the reproduced music file. According to an exemplary embodiment of the inventive concept, the volume of the music file may be controlled separately or independently from the main volume of the electronic device. According to an exemplary embodiment of the inventive concept, the volume of the music file may be adjusted to be relatively larger or smaller than the main volume of the electronic device.

As described above, the user may control the music reproduction by simply touching or sliding the music control window 40 when an exemplary embodiment of the inventive concept applies to a navigation service, thus allowing for increased user convenience when driving.

FIG. 19 is a screen view of an electronic device for reproducing a music file while in execution of an additional function according to an exemplary embodiment of the inventive concept.

Referring to FIG. 19, the display unit 120 may be split into a first portion 121 and a second portion 122 in upper and lower directions. An additional function screen 30 is displayed on the first portion 121, and a music control window 40 is displayed on the second portion 122.

According to an exemplary embodiment of the inventive concept, the music control window 40, together with the additional function screen 30, may be always displayed on the screen, thus allowing for music reproduction to be controlled more easily.

Predetermined information, such as music reproduction information including, but not limited to, a song title or a singer's name, may be displayed magnified on the music control window 40. According to an exemplary embodiment of the inventive concept, the music control window 40 may remain displayed on the second portion 122 even when the additional function screen 30 is touched.

On the service setting screen 20, the items, such as “time to re-display control window” and “stop music reproduction when control window is not shown,” may remain deactivated.

A volume control part 50 may be displayed on the second portion 122.

The control of the music reproduction function may be substantially the same as the control of the music reproduction function described above in connection with FIGS. 3 to 8.

For example, various types of control may be performed by touching the music control window 40 or by sliding a touch on the music control window 40.

According to an exemplary embodiment of the inventive concept, the split portions including the first portion 121 and the second portion 122 may have various positions or arrangements according to the user's convenience. For example, the first portion 121 may be positioned at a right side of the screen, and the second portion 122 may be positioned at a left side of the screen.

Alternatively, the first portion 121 may be positioned at a lower side of the screen, and the second portion 122 may be positioned at an upper side of the screen. The first portion 121 may be different in size from the second portion 122. Although FIG. 19 illustrates an example in which the first portion 121 is larger in size than the second portion 122, exemplary embodiments of the inventive concept are not limited thereto. Alternatively, the second portion 122 may be configured to be larger in size than the first portion 121. In such case, more music reproduction information including song titles or singers' names may be displayed in the second portion 122. The volume of music reproduction may be configured to be controlled.

Each of the aforementioned components of the electronic device may include one or more parts, and a name of the part may vary with a type of the electronic device. The electronic device in accordance with various embodiments of the present disclosure may include at least one of the aforementioned components, omit some of them, or include other additional component(s). Some of the components may be combined into an entity, but the entity may perform the same functions as the components may do.

As used herein, the term “user” may denote a person or device (e.g., artificial intelligence electronic device) using the electronic device.

The term ‘unit’ may refer to a unit including one of hardware, software, and firmware, or a combination thereof. The term ‘unit’ may be interchangeably used with a module, logic, logical block, component, or circuit. The unit may be a minimum unit or part of an integrated component. The unit may be a minimum unit or part of performing one or more functions. The unit may be implemented mechanically or electronically. For example, the unit may include at least one of Application Specific Integrated Circuit (ASIC) chips, Field Programmable Gate Arrays (FPGAs), or Programmable Logic Arrays (PLAs) that perform some operations, which have already been known or will be developed in the future.

At least a part of the device (e.g., modules or their functions) or method (e.g., operations) may be implemented as instructions stored in a computer-readable storage medium e.g., in the form of a programming module. The instructions, when executed by one or more processor (e.g., the controller 150), may cause the processor to carry out a corresponding function. The computer-readable storage medium may be e.g., the memory 140. At least a part of the programming module may be implemented by e.g., the controller 150. At least a part of the programming module may include e.g., a module, program, routine, set of instructions, process, or the like for performing one or more functions.

The computer-readable storage medium may include a hardware device configured to store and perform program instructions (e.g., programming module), such as magnetic media such as hard discs, floppy discs, and magnetic tapes, optical media such as Compact Disc ROMs (CD-ROMs) and Digital Versatile Discs (DVDs), magneto-optical media such as floptical disks, ROMs, RAMs, Flash Memories, and/or the like. Examples of the program instructions may include not only machine language codes but also high-level language codes which are executable by various computing means using an interpreter. The aforementioned hardware devices may be configured to operate as one or more software modules to carry out exemplary embodiments of the inventive concept, and vice versa.

Modules or programming modules in accordance with various embodiments of the present disclosure may include at least one or more of the aforementioned components, omit some of them, or further include other additional components. Operations performed by modules, programming modules or other components in accordance with various embodiments of the inventive concept may be carried out sequentially, simultaneously, repeatedly, or heuristically. Furthermore, some of the operations may be performed in a different order, or omitted, or include other additional operation(s).

In accordance with various embodiments, provided is a storage medium having instructions stored thereon, the instructions, when executed by at least one processor, causing the at least one processor to perform at least one operation including: activating a first function and displaying a first screen associated with the first function; identifying whether a second function is selected while the first function is activated; when the second function is selected, executing the second function and displaying a window on a predetermined area of the first screen, the window providing information associated with the selected second function.

Several embodiments have been described, but a person of ordinary skill in the art will understand and appreciate that various modifications can be made without departing the scope of the inventive concept.

1. An electronic device, comprising:
an input unit configured to receive information generated by manipulating a key or a menu;
a controller configured to execute a first function according to the information received from the input unit; and
a display unit configured to display an image associated with a control signal from the controller, wherein the controller is configured to, when a second function is selected while the first function is executed, execute the second function and display a window on a predetermined area of a first screen on which the execution of the first function is displayed, the window providing information associated with the selected second function.

2. The electronic device of claim 1, wherein the controller is configured to hide the window and to re-display the window after a predetermined time in response to a signal generated by touching a portion other than the window.

3. The electronic device of claim 1, wherein the controller is configured to overlay the window on the predetermined area of the first screen.

4. The electronic device of claim 1, wherein the controller is configured to split the first screen into two or more portions and to display the window on one of the two or more portions.

5. The electronic device of claim 1, further comprising a communication unit configured to connect the electronic device to a network, the controller configured to receive a music file from a server through the communication unit and to reproduce the music file.

6. The electronic device of claim 5, wherein the controller is configured to connect the electronic device to a second electronic device through the communication unit and to transmit a control signal to the second electronic device to control the second electronic device.

7. The electronic device of claim 1, wherein the controller is configured to perform different types of control in response to input signals generated by touching the window and sliding a touch on the window in different directions.

8. The electronic device of claim 7, wherein the controller is configured to stop the second function in response to a signal generated by a first touch on the window and to resume the stopped second function in response to a signal generated by a second touch on the window while the second function is stopped.

9. The electronic device of claim 7, wherein the controller is configured to display a volume control part in response to a signal generated by double-touching the window, the volume control part configured to allow a user to control the sound volume of the electronic device.

10. The electronic device of claim 7, wherein the second function is a music reproduction function, and wherein the controller is configured to reproduce a music file previous to a currently reproduced music file among music files stored in a memory in response to a signal generated by sliding a touch on the window in a first direction.

11. The electronic device of claim 7, wherein the second function is a music reproduction function, and wherein the controller is configured to reproduce a music file next to a currently reproduced music file among music files stored in a memory in response to a signal generated by sliding a touch on the window in a second direction.

12. The electronic device of claim 7, wherein the controller is configured to display a setting screen for setting the window in response to a signal generated by sliding a touch on the window in a third direction.

13. The electronic device of claim 7, wherein the second function is a music reproduction function, and the controller is configured to display predetermined information including a song title and a singer's name at a predetermined position of the first screen in response to a signal generated by sliding a touch on the window in a fourth direction.

14. The electronic device of claim 1, wherein the controller is configured to adjust a transparency of the window.

15. The electronic device of claim 1, wherein the controller is configured to change a color of a portion or whole of the window according to whether the second function is executed.

16. The electronic device of claim 1, wherein the second function is a music reproduction function, and wherein the information associated with the second function includes at least one of a song title, a singer's name, an album image, or a music file reproduction time.

17. A method for controlling an electronic device, the method comprising:
activating a first function and displaying a first screen associated with the first function,
identifying whether a second function is selected while the first function is activated;
when the second function is selected, executing the second function and displaying a window on a predetermined area of the first screen, the window providing information associated with the selected second function.

18. The method of claim 17, further comprising performing different types of control in response to input signals generated by touching the window and sliding a touch on the window in different directions.

19. The method of claim 17, further comprising changing a color of a portion or whole of the window according to whether the second function is executed.

20. An electronic device, comprising:
an input unit configured to receive information generated by manipulating a key or a menu;
a controller configured to execute an additional function according to the information received from the input unit; and
a display unit configured to display an image associated with a control signal from the controller, wherein the controller is configured to, when a music playing function is selected while the additional function is executed, execute the music playing function and display a music control window on a predetermined area of a first screen on which the execution of the additional function is displayed, the music control window providing information associated with the selected music playing function, wherein the controller is configured to perform different types of control in response to input signals generated by touching the music control window and sliding a touch on the music control window in different directions, and wherein the controller is configured to change a color of a portion or whole of the music control window according to whether the music playing function is executed.
